(19) United States
(12) Patent Application Publication
(10) Pub. No.: US 2010/0041829 A1
(43) Pub. Date: Feb. 18, 2010

(54) POLYMER STRING

(76) Inventor: Dominique VAN MALDEREN, Schilde (BE)

Correspondence Address: BACON & THOMAS, PLLC, 625 SLATERS LANE, FOURTH FLOOR, ALEXANDRIA, VA, 22314-1176, US

(21) Appl. No.: 12/540,093

(22) Filed: Aug. 12, 2009

(30) Foreign Application Priority Data
Aug. 14, 2008 (BE) 2008/0451

(51) Int. Cl. C08L 53/00; C08L 33/04; C08L 33/02; B29C 47/88; H05H 1/24

(52) U.S. Cl. 525/94; 525/222; 525/221; 264/210.1; 264/469

(57) ABSTRACT

Polymer string mainly but not exclusively consisting of one or several plastics, characterised in that at least one plastic consists of a thermoplastic material in which at least one alkylbenzyl ester of a 1,2 dicarboxylic acid or one of its derivates is distributed homogeneously, that the alkyl chain of the alkyl-benzyl ester or one of its derivates consists of at least five carbon atoms, and that it is used in a concentration between 0.1 to 5 percent by weight, better between 0.3 to 4 percent by weight, and even better between 0.3 to 1.2 percent by weight.

The present invention concerns a polymer string.

This mainly includes, but is not limited to, a polymer string that can be used for stringing rackets for ball sports such as for example tennis, squash, racket ball, badminton, and the like.

Such a string can however also be applied to the fishing sport, to musical instruments, etcetera.

The invention also concerns a method for manufacturing such a string.

Within this context there are already various types of string that have been marketed either in the shape of a monofilament, or multifilament, or bi-component string.

Combinations of various string types mutually exist as well.

For example, in case of the so-called ‘hybrid strings’, it is known to use monofilamentous string for the stringing of a tennis racket lengthwise, and multifilament string for stringing thereof widthwise.

The various string types all have their typical characteristics, always with their specific advantages and disadvantages.

These are not limited to the typical physical, chemical, or sensory characteristics, but are also situated in the field of the playing characteristics.

Ball control for example is better when playing softly with a multifilamentous string, whereas when playing hard the monofilamentous string on the other hand allows for a better control.

There is, for example, known a monofilamentous string for tennis rackets of the company Monofil-Technik GmbH, as it is described in DE 199 31 860.

This string is produced in an extrusion process, starting from a melted mixture of a thermoplastic polyester with a thermoplastic polyester elastomer as the base material.

To this end one selects as thermoplastic elastomer for example an elastomer polyether ester or a co-polyether ester, the latter being constructed from a sequence of segments of polybutylene terephthalate and polytetrahydrofurane respectively.

The thermoplastic polyester can then, for example, consist of polyethyleneterephthalate or poly (1,4 cyclohexane dimethyleneterephthalate).

To 100 weight parts of thermoplastic polyester, for example between 4 to 50 weight parts of thermoplastic polyester elastomer are added in molten condition in order to obtain the intended characteristics.

The final practical string thickness for applications in tennis rackets amounts to 1.2 to 1.4 mm after extrusion and stretching, which is quite a lot.

With this type of string the playing characteristics are largely determined by the diameter, reaching from elastic to durable.

Such strings are generally relatively stiff and tend to lose their tension quickly, as a result of which the control diminishes and the string feels ‘dead’.

On the other hand for example US 2001/0035002 describes a plastic string for tennis rackets that is implemented as a multifilamentous string and which is characterised by an increased resistance to friction.

To this end a central bundle of plastic filaments is then started from that can be composed of various polymers. These filaments are embedded in and surrounded by a matrix consisting of nylon or polyurethane, in which between 11 and 50 weight percent PTFE particles are dispersed homogeneously.

The reduction of the adhesion between the various constituting parts, especially between the PTFE particles and the surrounding matrix, can, under certain playing circumstances, cause certain shapes of delamination or defoliation of the string, as a result of what its useful life span is shortened and the characteristics tend to deteriorate.

Also known, for example from US 2003/0145574 and U.S. Pat. No. 6,009,699 are the compounded strings for tennis rackets, consisting of a combination of twisted-pair mono and multifilaments, in which the monofilaments show at least one flat side, whereas the multifilaments are round in cross section, and they are applied in a spiral shaped structure around the longitudinal axis of the string, and in which the whole construction is finally surrounded by and held together by a matrix consisting of polyurethane.

This matrix is applied as a solution in a solvent, upon which the solvent needs to be evaporated. Subsequently, the string is pulled through a calibrating opening in order to adjust the string thickness, and after it has hardened, it will be stretched and folded under a sharp angle, in order to regain a delamination of the compound components and to make the central monofilaments by the transparent polyurethane matrix appear.

The ultimate objective of this is that the stiffer monofilaments, after wearing of the surrounding polyurethane matrix, will be at the surface of the string, in order to form points of contact with the adjacent strings during the further useful lifespan of the string.

The method that was used is rather complicated and therefore expensive, and furthermore shows other disadvantages in the fields of the environment and safety.

All these designs according to the state of the art however have the disadvantage that the desired characteristics of the produced string can only be adjusted within narrow limits, or are strongly susceptible to changes as a result of mechanical wear or other unfavourable influences.

Due to these and other reasons, these strings are therefore produced rather thickly, which in turn has a negative influence on the playing characteristics.

It is commonly known that a soft stringing of the racket, in combination with a thin string with optimised elasticity provides a faster ball speed, as a result of which less force is needed in order to return the ball.

Thinner strings provide ‘more power’, more ‘spin’, and more ‘feeling’ as it is called in professional terms.

Also, it is known that stiffer and thicker strings are less suitable for the prevention of elbow, arm, or shoulder problems, because they are less elastic, less shock absorbing, and give in less than strings with a smaller diameter.

It is therefore a normal procedure that by prior incorporation of various additives in plastic materials one tries to further improve or expand the useful field of application and life span of such strings, as well as their playing characteristics.

In this context the use of aliphatic di-esters created from phtalic acid or phtalic acid anhydride and an alkanol that is either branched or unbranched, added in molten form to the plastic or the plastics mixture, before the actual extrusion of the string is carried out.

Current examples of such additives are, amongst others: bis (2-ethylhexylphtalate (DEHP), diisononylphtalate (DINP), dibutylphtalate (DBP), di-ethylphtalate (DEP), dimethylphtalate (DMP), di-n-hexylphtalate (DUP), di-n-octylphtalate (DnOP, di-isodecylphtalate (DIDP), and related compounds.

A known disadvantage of these aliphatic diesters is however, that mostly high melting temperatures have to be used and longer mixing times have to be observed in order to fully include these compounds in the respective plastic or the plastic mixture and to spread them homogeneously.

This high melting temperature and these long mixing times can in turn then inflict health problems on the employees.

The used additives under the respective production circumstances, are namely characterised by a higher volatility, and thus possess an inherently higher degree of toxicity.

Therefore, during the processing specific preventive measures with regard to personal protection and/or with regard to general safety measures have to be taken, which inevitably has to be regarded as an additional disadvantage.

Also, the high processing temperature and the longer mixing times tend to result in an undesired thermal load of the molten mixture itself, with possible degradation of discolouring of the temperature—or oxidation sensitive ingredients as a direct result, coupled with increased chemical-physical wear of the processing and production means.

A known disadvantage is also that these aliphatic diesters or related compounds tend to influence the compatibility of the various ingredients or components with each other in a negative sense.

This can, as is commonly known, then also result in a premature ageing of the produced string because of increased loss of elasticity or by delamination or defoliation of the composing parts or by sweating out the additives in function of time under the influence of external factors.

Summarising, one could state that regardless of the type of plastic string and despite of the usual incorporation of additives, for example on the basis of di-alkyl esters of phthalic acid, the desired stable playing characteristics such as ‘durability’, comfort, spin, ball feeling, performance, etc. in accordance with the state of the art can only be obtained by offering strings with a relatively large diameter and/or of greater complexity.

For the production often long-lasting and complex, and therefore expensive processes have to be called upon, with a certain inherent toxicity risk, high energy use, higher use of materials, high waste percentage, higher burden on the environment, higher emission of greenhouse effect gasses, and the like.

Creating a thinner string with more stable characteristics, long useful life span, and this according to a simple processing method, is therefore a very desirable, but at the current state of the art still not a satisfactorily completely obtainable target.

The present invention has the objective to offer a solution to the aforementioned and other disadvantages, more precisely a thinner string with more stable characteristics and better playing characteristics, that can moreover be processed in accordance with a simple process, because it provides for a plastic string, mainly but not necessarily, only consisting of one or several plastics, at which at least one plastic consists of thermoplastic material, in which at least one alkyl-benzyl ester of a 1,2 dicarboxylic acid of one of its derivates, is homogeneously distributed, in which the alkyl chain of the alkyl-benzyl ester or one of its derivates consists of at least five carbon atoms and at which use is made of a concentration between 0.1 to 5 percent by weight, better between 0.3 to 4 percent by weight, or even better between 0.3 and 1.2 percent by weight.

A remarkable advantage of a string according to the invention is that the spread of its physical characteristics, especially its loop strength, is strongly narrowed, whereas the absolute value of it has increased.

This allows for obtaining more stable characteristics and better playing characteristics of the string, by decreasing the diameter of the string and thus also realise optimal ball control in combination with a high performance.

Another advantage is that considerable savings in raw materials and energy use can be realised due to the fact that the diameter of the strings can be visibly reduced, whilst maintaining ample sufficient pulling strength to guarantee a minimum life span.

Also, because of the smaller spread on the mechanic characteristics, less waste and in connection to that, less raw materials and energy use are concerned, together with lower costs in order to dispose of the waste materials.

A further remarkable advantage of the invention is that the inventor succeeded to also have made these alkyl-benzyl esters or their derivates, that are mainly compatible with PVC or PVC-like materials or acrylates, compatible with plastics that were previously regarded as not compatible with, or with limited compatibility for this family of compounds.

This allows for the creation of plastic strings according to the invention that are mainly constructed of one or several plastics or plastic mixtures selected from one or several of the following groups of plastics or plastic families: PET, co-PET, PLA, PBT, PPT, PA and/or co-polymers of these materials, PEEK, PPS, polyether-polyester block polymer, polyether-polyamide block polymer, TPU, PVDE and/or other fluoropolymers.

The invention also provides a process for the production of such a string at which the alkylbenzyl ester prior to at least one molten plastic or plastic mixture for the creation of a homogeneous thermoplastic mixture is added in order to extrude, either one at a time or together with other plastics or plastic mixtures in accordance with a desired pattern.

The extruded mixture is then cooled for the creation of the string, which is then stretched, and subsequently relaxed back, in order to be coiled on a bobbin or something similar.

The thus produced string can, when the need arises, also be subjected to a surface treatment, for example to a plasma treatment, for the improvement or adjustment of the surface characteristics.

At this stage, useful use is made of the lower melting temperature of the stated alkyl-benzyl esters or their derivates and of their rheology modifying effect on the melting and of their lower toxicity upon processing.

Therefore, because of the latter, no specific protective measures have to be taken during processing, neither with regard to personal protection, nor with regard to general safety measures.

Furthermore, this process according to the invention allows to adjust the compatibility of the various constituting parts better to each other, so that mutual delamination or defoliation of materials, fillers, additives and the like that cannot be fully mixed with each other can be limited to a minimum under the most unfavourable playing conditions or influences from the outside.

A huge advantage of the invention at this stage is that the processing characteristics of the constituting plastics or plastic mixtures in a molten state, followed by the extrusion process and an enhancement of the string and the final characteristics of the string, can be adjusted and optimised in a simple manner, and even in a far wider range than was deemed possible so far.

Another remarkable advantage is that the processing temperature and the total mixing hours can be limited, which is not only time and energy saving and more environmentally friendly, but also has a positive influence on the temperature sensitive ingredients that will be less subjected to discolouration or deterioration.

At the same time, the production means will be subjected to less aggressive circumstances and shorter production times, which also entails a prolongation of their useful lifespan and a reduction of the maintenance or repair sessions.

A further remarkable advantage is that due to the stricter spread of the physical and chemical characteristics, a better control and adjustment of the processing parameters is possible, which in turn results in the fact that less adjustment is necessary, and that savings on raw materials and energy use and a decrease of the waste and the waste processing percentage are realised.

The latter can be achieved by making use of the process according to the invention, as a result of which it is reduced with at least 10%.

With the intention to better demonstrate the characteristics of the invention, below as an example without any limiting nature, a preferential implementation design is described as a string according to the invention, under reference to Table 1 that is included.

Furthermore, the physical characteristics of three standard strings A, B, C, implemented according to the state of the art, and in which classical diphthalic acid esters are used as additives, are compared with those obtained from a string of the same diameter, but constructed and produced according to the invention.

In Table 1 the comparison is made of a standard produced monofilamentous string A and/or B, and a bi-component string C, in each case with the same string in which as an alkylbenzyl ester the C7-C9 alkyl ester is used with a mixture of branched or unbranched aliphatic chains, according to the invention, mainly consisting of isononyl-benzyl phthalate however.

The physical characteristics such as elasticity modulus, pulling strength, loop strength and spread of the values of the loop strength, are indicated on the basis of the string type (monofilamentous A, B, or bi-component C) and on the basis of the percent by weight of isononyl-benzyl phthalate that was added.

The standard monofilamentous string has a diameter of 1.25 mm.

Table 1 shows the various values that were measured of the modulus, pulling strength, and loop strength, as well as the spread of the latter.

The values for a string that contains, according to the invention, an alkylbenzyl ester or a derivate thereof, more specifically isononylbenzylphthalate, in a concentration of 0.3 percent by weight and at the same string diameter, are subsequently displayed in there.

A clear reduction of the spread can be observed for the loop strength (down from 100 to 20) and a slightly higher elasticity modulus (from 4200 MPa to 4500 MPa), in comparison with the standard string A that does not contain alkyl-benzyl ester or a derivate thereof.

In a further example, the diameter of the standard monofilamentous string A is reduced from 1.25 mm to 0.99 mm, which is now indicated by referring to string B.

The following values are encountered as a typical result.

A standard string without alkylbenzyl ester or a derivate thereof was not usable with a diameter of 0.99 mm, since not only the pulling strength was too low (421 N), but also furthermore the loop strength was also too weak (495 N) and the spread (130) too large.

For the string that contains the alkylbenzyl ester or a derivate thereof according to the invention, the values were measured at two concentrations, with 0.3 and 0.9 percent by weight respectively.

At 0.3 percent by weight, the pulling strength still turned out to be low (413 N), whilst still being a good modulus (4754 MPa), a better loop strength (600 N) and a narrower spread (40) were encountered.

Finally, at 0.9 percent by weight it turned out that the encountered parameters complied (modulus 5000 MPa), at almost equal pulling strength (417 N), but we encountered an improved loop strength (694 N) and a very narrow spread (25) of the latter.

In case of a standard bi-component string C, as an example chosen and with a diameter of 1.25 mm, we obtain a similar picture.

Incorporation of 1 percent by weight of isononyl-benzyl ester according to the invention, especially results in a higher loop strength (940 N compared to 899 N) at a remarkably stricter spread of the latter (45 instead of 100).

The conclusion of the measurements that were displayed as a means of an example and to clarify the invention, can be summarised as follows.

At a standard monofilamentous string with a diameter of 1.25 mm, the use of the alkylbenzyl ester (ABPt) or a derivate thereof, especially isononylbenzyl phthalate, a comparable or higher pulling strength and modulus can be observed than with a string that was constructed in accordance with the current state of the art, and it furthermore has a stricter spread of the physical and chemical basic characteristics.

At the string with a diameter of 0.99 mm that contains, in accordance with the current state of the art, an alkylbenzyl ester or a derivate thereof, the pre-set values were never obtained.

On the other hand, for the string with a diameter of 0.99 that, according to the invention, contains 0.3 percent by weight of alkyl-benzyl ester or a derivate thereof, especially isononyl-benzyl phthalate, still a part of the quality requirements were complied with, with especially a very strict spread of the loop strength as the main characteristic.

At the string with a diameter of 0.99 mm that, according to the invention, contains 0.9 percent by weight of alkyl-benzyl ester or a derivate thereof, especially isononyl-benzyl phthalate, all quality requirements were complied with however, also combined with a considerably stricter spread of the loop strength as the main characteristic.

This all demonstrates that according to the invention a thinner string, with improved processing characteristics, together with improved physical and playing characteristics is realised, furthermore provided with the additional advantages as stated above.

With the intention to better demonstrate the characteristics of the invention, below as an example without any limiting nature, a preferential process is described for the production of a string according to the invention.

Thus, the plastic string is produced according to the invention by means of a so-called melt-spinning procedure.

This means that the plastic or the plastic mixture is first molten, and subsequently spun into a thread on an extrusion installation.

The alkylbenzyl ester or its derivate, especially isononylbenzyl phthalate, is mixed mechanically into the molten plastic or the plastic mixture in a mixing vessel, so that a uniform division is obtained for the whole batch.

Since the alkylbenzyl ester or a derivate thereof that was used according to the invention has, under the respective processing circumstances only a limited or no toxic effect, contrary to the di-alkyl esters of phthalate acid used in accordance with the current state of the art, no specific precautionary or protective measures are necessary when mixing in the alkylbenzyl ester, or of a derivate thereof in the polymer compound or during the subsequent extrusion thereof.

The concentration of the alkylbenzyl ester or its derivates, especially isononylbenzyl phthalate, consists at that of 0.1 to 5 percent by weight, preferably 0.3 to 1.2 percent by weight.

The extrusion installation classically consists of an extruder with dosing unit, extruder screw, cover with various temperature zones, spinning pump, filter and spinning plate.

The molten material will then, after having been extruded, end up in a cooling installation, consisting of a waterbed in the case of monofilaments and bi-component monofilaments, or of a cooling shaft with cold air in the case of multifilaments and bi-component multifilaments.

After the cooling process a phase of stretching takes place by means of a rollers system. The stretching can range between 2 to 12 times, with a preference for 4 to 8 times.

After the stretching phase follows a short relaxation step, followed by coiling it around a bobbin.

This procedure according to the invention is in principle the same for both the extrusion and production of monofilamentous and of multifilamentous and/or bi-component strings and/or a combination of one or several thereof.

In case of bi-component strings it is preferred to operate with what in professional terms is indicated as an ‘island in the sea’ or ‘core/sheet’ types of designs.

An ‘island in the sea’ designs the string in principle and consists of one or several plastics, mostly with a higher modulus, that can be regarded as cores, and that are embedded and kept in place by other plastics that serve as a matrix, and that generally speaking have a higher degree of elasticity.

The diameter of the string displays the image that shows similarities to a multitude of ‘little islands’ spread in and surrounded by a component that is then called the ‘sea component’.

At ‘core/sheet’ types however, it is principally about a string that is exclusively constructed of a core material with higher modulus that is then surrounded by a more flexible matrix.

If necessary the shaped strings can still be subjected to a surface treatment, for example to a plasma treatment, for the adjustment or improvement of the surface characteristics, for example to pressurising.

The present invention is by no means limited to the implementation form(s) described as an example and/or method, but a string according to the invention and a method for manufacturing this can be realised in all shapes and sizes and in various ways, without leaving the scope of the invention.

TABEL 1

| | | modulus | treksterkte | lussterkte | |
|---|---|---|---|---|---|
| drm (mm) | | (MPa) | (N) | (N) | spreiding |
| 1.25 | snaar A | 4200 | 550 | 900 | 100 |
| | snaar A + 0.3% | 4500 | 527 | 885 | 20 |
| | ABPt | | | | |
| 0.99 | snaar B | 4351 | 421 | 495 | 130 |
| | Snaar B + 0.3% | 4754 | 413 | 600 | 40 |
| | ABPt | | | | |
| | Snaar B + 0.9% | 5000 | 417 | 694 | 25 |
| | ABPt | | | | |
| 1.25 | snaar C bico | 3049 | 592 | 899 | 100 |
| | snaar C bico + | 2551 | 499 | 940 | 45 |
| | 1% ABPt | | | | |

ABPt = alkyl-benzylphtalaat

1. Polymer string comprising one or several plastics, said plastic or at least one of said plastics comprising thermoplastic material, in which at least one alkyl-benzyl ester of a 1,2 di-carboxylic acid, or one of its derivates is distributed homogenously, and wherein the alkyl chain of the alkyl-benzyl ester or of one of its derivates, comprises at least five carbon atoms and is used in a concentration between 0.1 to 5 percent by weight.

2. Polymer string according to claim 1, wherein said string is fully or partially constructed from thermoplastic polymers, optionally with thermoplastic elastomers, selected from one or several polymers from the following groups: PET, PLA, PBT, PPT, PA, PEEK, PPS, polyether-polyester block polymer, polyether-polyamide block polymer, TPU, PVDF, other fluorinated polymers, and/or co-polymers of one or several of these compounds.

3. Plastic string according to claim 1, wherein the alkyl-benzyl ester of the 1,2 carboxylic acid comprises a di-ester of phthalic acid or phtalic acid anhydride, with on one hand a benzyl group and on the other hand an alkyl group with 5 to 12 carbon atoms.

4. Polymer string according to claim 1, wherein the alkyl group of the alkyl-benzyl ester, or a derivate thereof, comprises a mixture of various isomers.

5. Method for manufacturing a plastic string according to claim 1, wherein the alkyl-benzyl ester is added in advance to at least one molten plastic or plastic mixture for the creation of a homogeneous thermoplastic mixture.

6. Method according to claim 5, wherein alkyl-benzyl ester is added in a concentration between 0.1 to 5 percent by weight.

7. Method according to claim 5, wherein at least one plastic or plastic mixture is selected from the group of plastics consisting of PET, PLA, PBT, PPT, PA, PEEK, PPS, polyether-polyester block polymer, polyether, polyamide block polymer, TPU, PVDF, other fluorinated polymers, and/or copolymers of one or several of these compounds.

8. Method according to claim 5, wherein the thermoplastic mixture is subsequently extruded and the extruded mixture is further cooled for the creation of a string, which is then stretched, and subsequently relaxed back, and then coiled on a bobbin or the like.

9. Method according to claim 5, wherein the created string is finally subjected to a surface treatment, for example to a plasma treatment in order to improve or adjust the surface characteristics.
